(19) United States
(12) Patent Application Publication
(10) Pub. No.: US 2024/0020165 A1
(43) Pub. Date: Jan. 18, 2024

(54) INFORMATION PROCESSING SYSTEM AND INFORMATION PROCESSING METHOD

(71) Applicant: Actapio, Inc., East Wenatchee, WA (US)

(72) Inventor: Shinichiro OKAMOTO, Wenatchee, WA (US)

(21) Appl. No.: 18/075,033

(22) Filed: Dec. 5, 2022

Related U.S. Application Data
(60) Provisional application No. 63/389,198, filed on Jul. 14, 2022.

(51) Int. Cl. G06F 9/50; G06F 9/48

(52) U.S. Cl. CPC G06F 9/5038; G06F 9/4881

(57) ABSTRACT

An information processing system according to the present application is an information processing system including a plurality of nodes including a first node and a second node that execute distributed processing, in which the first node creates a job list including a plurality of jobs into which information processing requested to be processed in the information processing system is divided, and stores the created job list into a common storage accessible to each of the plurality of nodes, and the second node refers to the common storage, determines a targeted job being a job in the job list that is to be set as a processing target, and updates the job list after processing of the targeted job.

### TECHNICAL FIELD

The present invention relates to an information processing system and an information processing method.

### BACKGROUND ART

Various techniques related to a distributed processing system that performs distributed processing have been conventionally provided. For example, a technique of shortening a completion time of the entire job by a master server allocating processing to a plurality of slave servers is provided.
[Patent Literature 1] JP 2015-170054 A

### DISCLOSURE OF INVENTION

### Problem to be Solved by the Invention

Nevertheless, in the above-described prior art, there is room for improvement. For example, in the above-described prior art, a master server needs to allocate processing (job) to a plurality of slave servers, and each slave server performs allocated processing after the master server performs allocation. The slave servers therefore cannot start processing without allocation performed by the master server, and it is sometimes difficult to appropriately perform distributed processing.

The present application has been devised in view of the foregoing, and aims to provide an information processing system and an information processing method that enable appropriate distributed processing.

### Means for Solving Problem

An information processing system according to the present application is an information processing system including a plurality of nodes including a first node and a second node that execute distributed processing, in which the first node creates a job list including a plurality of jobs into which information processing requested to be processed in the information processing system is divided, and stores the created job list into a common storage accessible to each of the plurality of nodes, and the second node refers to the common storage, determines a targeted job being a job in the job list that is to be set as a processing target, and updates the job list after processing of the targeted job.

### Effect of the Invention

According to an aspect of an embodiment, such an effect that appropriate distributed processing can be enabled is caused.

### BRIEF DESCRIPTION OF DRAWINGS

FIG. 1 is a diagram illustrating a configuration example of an information processing system according to an embodiment;

FIG. 2 is a diagram illustrating an example of processing to be executed by an information processing system according to an embodiment;

FIG. 3 is a flowchart illustrating a procedure of processing in an information processing system;

FIG. 4 is a diagram illustrating an outline of processing in an information processing system;

FIG. 5 is a diagram illustrating a configuration example of a server device according to an embodiment;

FIG. 6 is a flowchart illustrating a procedure of processing according to an embodiment; and

FIG. 7 is a diagram illustrating an example of a hardware configuration.

### BEST MODE(S) OF CARRYING OUT THE INVENTION

Hereinafter, a mode for carrying out an information processing system and an information processing method according to the present application (hereinafter, will be referred to as an “embodiment”) will be described in detail with reference to the drawings. Note that the information processing system and the information processing method according to the present application are not limited to the embodiment. In addition, in each embodiment to be described below, the same components are assigned the same reference numeral, and the redundant description will be omitted.

### Embodiment

[1. Information Processing System Outline]

Hereinafter, information processing (distributed processing) to be executed by an information processing system 1 including a distributed processing system 2 will be described. For example, the information processing system 1 is implemented using a technique related to Kubernetes, which is an open-source container orchestration system. Note that a technique used by the information processing system 1 is not limited to the Kubernetes, and the information processing system 1 may be implemented by appropriately using an arbitrary technique as long as information processing to be described below is executable.

In addition, an example case where a first node 10 is a master node and second nodes 20a and 20b, and the like are slave nodes will be described below. In a case where the second nodes 20a and 20b, and the like will be described without specific distinction, the second nodes 20a and 20b, and the like will be described as “second nodes 20” in some cases. In addition, in a case where the first node 10 and the second nodes 20 will be described without specific distinction, the first node 10 and the second nodes 20 will be simply described as “nodes” in some cases.

[1-1. Configuration Example of Information Processing System]

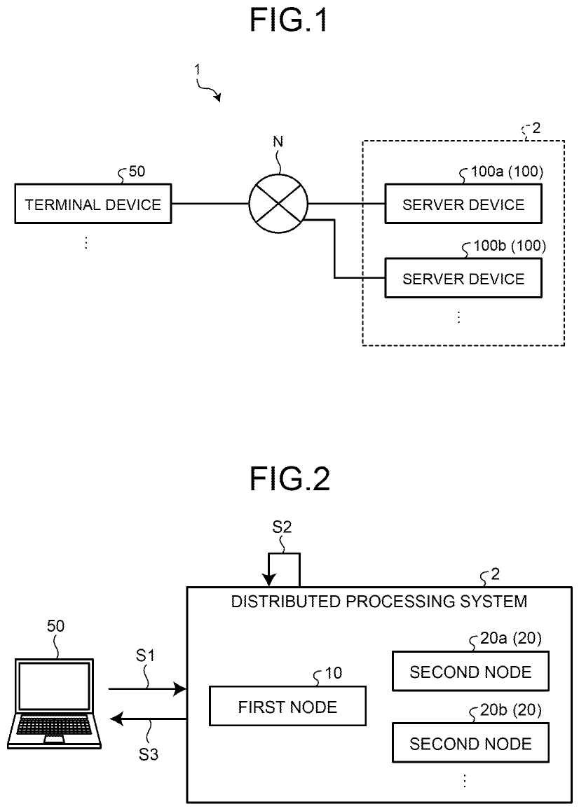

An example of a device configuration of the information processing system 1 that performs the above-described processing will be described using FIG. 1. FIG. 1 is a diagram illustrating a configuration example of an information processing system according to an embodiment. As illustrated in FIG. 1, the information processing system 1 includes a terminal device 50 and the distributed processing system 2. The terminal device 50 and the distributed processing system 2 are connected via a predetermined communication network classification (network N) in such a manner that communication can be performed in a wired or wireless manner. In the example illustrated in FIG. 1, the distributed processing system 2 includes a server device 100a, a server device 100b, and the like. Note that FIG. 1 only illustrates the server device 100a and the server device 100b, but included server devices are not limited to the server device 100a and the server device 100b, and three or more server devices 100 such as a server device 100c and a server device 100d may be included. In addition, in a case where the server device 100a, the server device 100b, and the like will be described without specific distinction, the server device 100a, the server device 100b, and the like will be described as server devices 100. The terminal device 50 communicates with at least one server device 100.

The terminal device 50 is an information processing device to be used by an arbitrary actor (hereinafter, will also be referred to as a “user”) such as an administrator of the distributed processing system 2. The terminal device 50 may be any device as long as processing in an embodiment is executable. For example, the terminal device 50 may be a device such as a smartphone, a tablet terminal, a laptop personal computer (PC), a desktop PC, a mobile phone, or a personal digital assistant (PDA). In the example illustrated in FIG. 2, a case where the terminal device 50 is a laptop PC is illustrated.

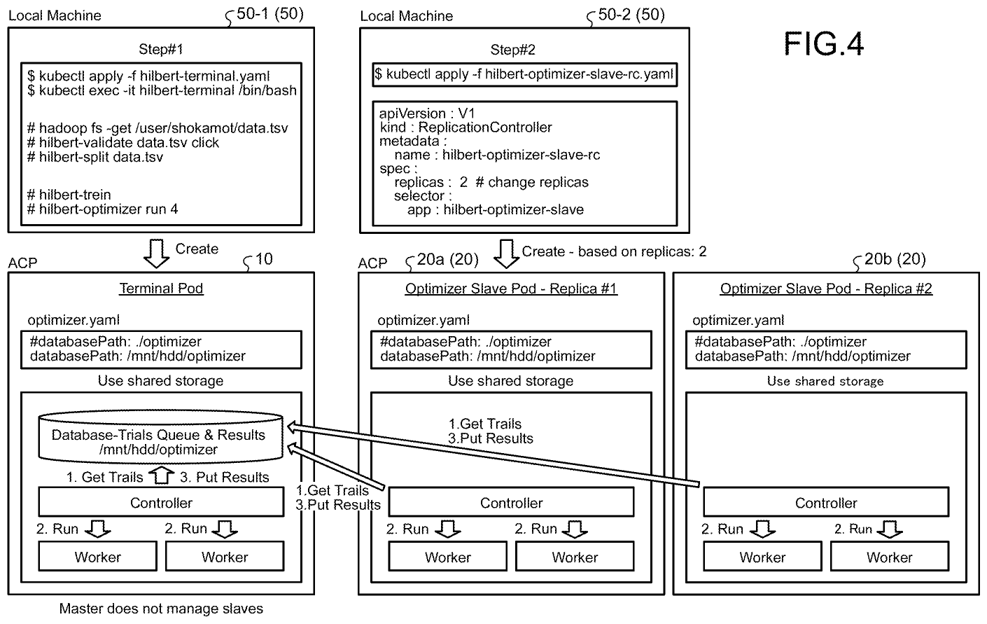

The terminal device 50 receives, from a user, the entry of command information such as a command for commanding the distributed processing system 2 to execute distributed processing. The terminal device 50 displays a screen (command entry screen) for receiving command information of the user. The terminal device 50 receives the command information of the user that has been entered into the displayed command entry screen. For example, the terminal device 50 receives the entry of command information as illustrated in terminal devices 50-1 and 50-2 in FIG. 4. The terminal device 50 transmits the command information to the distributed processing system 2.

The distributed processing system 2 is a system that performs distributed processing. The distributed processing system 2 includes a plurality of server devices 100 that executes distributed processing. Devices included in the distributed processing system 2 are not limited to the server devices 100, and the distributed processing system 2 may include various devices. For example, the distributed processing system 2 may include a management device that performs various types of management related to distributed processing to be executed by the server devices 100, based on command information from the user. For example, the management device of the distributed processing system 2 may communicate with the terminal device 50 and receive command information, and each server device 100 may execute distributed processing based on the command information from the management device. Note that the management device may be the server device 100 corresponding to a master node. For example, the management device may be the server device 100 corresponding to the first node 10. Note that the above-described device configuration is merely an example, and the distributed processing system 2 can employ an arbitrary device configuration as long as the distributed processing system 2 can execute desired processing.

The server device 100 is a device serving as an execution actor of distributed processing, for example. The server device 100 is implemented by an arbitrary computer. For example, the server devices 100 are connected in such a manner that communication can be executed via a network existing inside the distributed processing system 2. Note that the server devices 100 may be connected in such a manner that communication can be executed, in any configuration as long as distributed processing is executable. The details of the server device 100 will be described later. Hereinafter, processing to be performed by the server device 100 corresponding to each node will be briefly described.

The server device 100 corresponding to the first node 10 creates a job list including a plurality of jobs into which information processing requested to be processed in the information processing system 1 (will also be referred to as “targeted information processing”) is divided. Note that the server device 100 may create a plurality of jobs into which the targeted information processing is divided, by any method as long as the targeted information processing is divided into a plurality of jobs. For example, the server device 100 may create a plurality of jobs by dividing targeted information processing using a dividing method appropriately selected in accordance with the content of the targeted information processing. The server device 100 corresponding to the first node 10 stores the created job list into a common storage accessible to each of a plurality of nodes.

The server device 100 corresponding to the first node 10 refers to the common storage, and determines a targeted job in the job list that is to be set as a processing target. The server device 100 corresponding to the first node 10 updates the job list after processing of the targeted job. The server device 100 corresponding to the first node 10 refers to a job queue set based on the job list, and determines a job included in the job queue, as a targeted job.

The server device 100 corresponding to the first node 10 corresponds to a master node. The server device 100 corresponding to the first node 10 sets a value of a first flag (Master execution flag) for managing an execution state of the own device (the first node 10). In a case where the first node 10 has started processing, the server device 100 corresponding to the first node 10 sets the first flag to a first value corresponding to ongoing. The server device 100 corresponding to the first node 10 ends the processing in a case where the first flag is set to a second value indicating that the processing of the first node 10 has been completed, and a second flag is set to a second value indicating that the processing of the second node 20 has been completed.

The server device 100 corresponding to the second node 20 refers to the common storage, and determines a targeted job being a job in the job list that is to be set as a processing target. The server device 100 corresponding to the second node 20 updates the job list after processing of the targeted job.

The server device 100 corresponding to the second node 20 corresponds to a slave node. The server device 100 corresponding to the second node 20 refers to the common storage, and determines an unprocessed job in the job list as a targeted job. The server device 100 corresponding to the second node 20 refers to a job queue set based on the job list, and determines a job included in the job queue, as a targeted job.

The server device 100 corresponding to the second node 20 sets a value of a second flag (Slave execution flag) for managing an execution state of the own device (the second node 20). In a case where the first flag is set to the first value, the server device 100 corresponding to the second node 20 refers to the common storage, determines a job as a targeted job, and executes processing of the targeted job. In a case where the second node 20 has started processing, the server device 100 corresponding to the second node 20 sets the second flag to a first value corresponding to ongoing.

The device configuration of the information processing system 1 that is illustrated in FIG. 1 is merely an example, and any configuration may be employed as long as information processing (distributed processing) to be described below is executable. Hereinafter, the information processing system 1 having the device configuration illustrated in FIG. 1 will be described an example.

[1-2. Information Processing Example]

An example of information processing according to an embodiment will be described using FIG. 2. FIG. 2 is a diagram illustrating an example of processing to be executed by an information processing system according to an embodiment. FIG. 2 illustrates an example case where the distributed processing system 2 executes distributed processing in response to a request from the terminal device 50 used by a user, and provides information regarding a processing result, to the terminal device 50.

First of all, a functional configuration of the information processing system 1 will be described. As illustrated in FIG. 2, the information processing system 1 includes the terminal device 50, a plurality of nodes such as the first node 10, the second node 20a, and the second node 20b, and the server device 100.

The first node 10 and the second node 20 illustrated in FIG. 2 are implemented by the server devices 100 illustrated in FIG. 1. Note that an arbitrary mode can be employed as an implementation mode of the first node 10, the second node 20, or the like that is implemented by the server device 100. For example, one node may be implemented by one server device 100, or one node may be implemented by a plurality of server devices 100. For example, the first node 10 may be implemented by a server device 100a, and each of the second nodes 20 may be implemented by another server device 100 other than the server device 100a. The first node 10 may be implemented by the server device 100a, the second node 20a may be implemented by the server device 100b, and the second node 20b may be implemented by the server device 100c.

The information processing system 1 is a system including a plurality of nodes including a first node and a second node that execute distributed processing. For example, the information processing system 1 includes the distributed processing system 2 that executes distributed processing by a plurality of nodes including the first node and the second node. The information processing system 1 executes the distributed processing using the first flag for managing an execution state of the first node 10, and the second flag for managing an execution state of the second node 20.

The first node 10 creates a job list including a plurality of jobs into which information processing (targeted information processing) requested to be processed in the information processing system 1 is divided. For example, the first node 10 creates a plurality of jobs by dividing targeted information processing by an arbitrary method appropriately using various prior arts. The first node 10 stores the created job list into a common storage accessible to each of a plurality of nodes. The first node 10 refers to the common storage, and determines a targeted job in the job list that is to be set as a processing target.

The first node 10 updates the job list after processing of the targeted job. The first node 10 refers to a job queue set based on the job list, and determines a job included in the job queue, as a targeted job.

The first node 10 is a master node. The first node 10 sets a value of the first flag (Master execution flag) for managing an execution state of the own node (the first node 10). In a case where the first node 10 has started processing, the first node 10 sets the first flag to a first value corresponding to ongoing. The first node 10 ends the processing in a case where the first flag is set to a second value indicating that the processing of the first node 10 has been completed, and the second flag is set to a second value indicating that the processing of the second node 20 has been completed.

The second node 20 refers to the common storage, and determines a targeted job being a job in the job list that is to be set as a processing target. The second node 20 updates the job list after processing of the targeted job.

The second node 20 is a slave node. The second node 20 refers to the common storage, and determines an unprocessed job in the job list as a targeted job. The second node 20 refers to a job queue set based on the job list, and determines a job included in the job queue, as a targeted job.

The second node 20 sets a value of the second flag (False execution flag) for managing an execution state of the own node (the second node 20). In a case where the first flag is set to the first value, the second node 20 refers to the common storage, determines a job as a targeted job, and executes processing of the targeted job. In a case where the second node 20 has started processing, the second node 20 sets the second flag to a first value corresponding to ongoing.

Note that, in a physical configuration, a processing actor of processing for which a node such as the first node 10 and the second node 20 is described as a processing actor is assumed to be a server device 100 corresponding to the node.

In the example illustrated in FIG. 2, the terminal device 50 transmits command information to the distributed processing system 2 (Step S1). For example, the user using the terminal device 50 enters command information by operating the terminal device 50, and causes the terminal device 50 to transmit command information. For example, the distributed processing system 2 receives the command information from the terminal device 50. For example, a management device of the distributed processing system 2 (for example, the server device 100 functioning as a management device) receives command information from the terminal device 50.

The distributed processing system 2 executes distributed processing (Step S2). For example, the distributed processing system 2 including the first node 10 and the second node 20 executes distributed processing based on command information. For example, the first node 10 creates a job list including a plurality of jobs into which information processing requested to be processed in the information processing system 1 is divided. The first node 10 stores the created job list into a common storage accessible to each of a plurality of nodes. The second node 20 refers to the common storage, and determines a targeted job being a job in the job list that is to be set as a processing target. The second node 20 updates the job list after processing of the targeted job. In addition, the first node 10 refers to the common storage, and determines a targeted job in the job list that is to be set as a processing target. The first node 10 updates the job list after processing of the targeted job.

The distributed processing system 2 provides information indicating a processing result of distributed processing, to the user (Step S3). For example, the distributed processing system 2 transmits information indicating a processing result of distributed processing, to the terminal device 50 used by the user being a command source. For example, a management device of the distributed processing system 2 (for example, the server device 100 functioning as a management device) transmits information indicating a processing result of distributed processing, to the terminal device 50 used by the user being a command source. For example, the terminal device 50 that has received a processing result of distributed processing from the distributed processing system 2 displays the processing result of the distributed processing.

[1-3. Procedure of Processing That Is Based on Master-Slave]

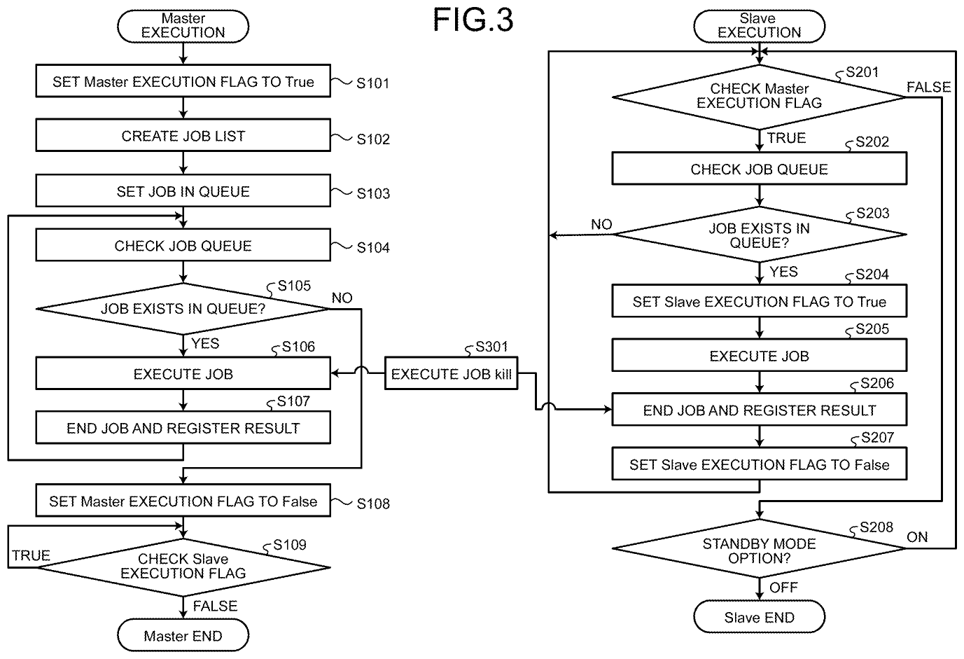

Next, a procedure of information processing that is based on master-slave in the information processing system 1 will be described using FIG. 3. FIG. 3 is a flowchart illustrating a procedure of processing in an information processing system.

As illustrated in FIG. 3, in the information processing system 1, the first node 10 serving as a master node sets a Master execution flag to True (Step S101). For example, the first node 10 sets the Master execution flag (first flag) to a state (first value) indicating that the master node is executing processing. For example, the first node 10 changes a value of the first flag to the first value.

Then, in the information processing system 1, the first node 10 creates a job list (Step S102). For example, the first node 10 creates a job list including a plurality of jobs. For example, the first node 10 divides a task allocated to the distributed processing system 2, into a plurality of jobs, and creates a job list including a plurality of divided jobs.

Then, in the information processing system 1, the first node 10 sets a job in a queue (Step S103). For example, the first node 10 creates a queue (will also be referred to as “job queue”) by setting a plurality of jobs included in a job list, in the queue. For example, by performing processing (enqueue) of adding each of a plurality of jobs included in a job list, to a queue, the first node 10 creates a job queue in which a plurality of jobs included in a job list is held in a first-in first-out list structure (queue structure). For example, the first node 10 stores the created job queue into a common storage accessible to each of a plurality of nodes.

Then, in the information processing system 1, the first node 10 checks a job queue (Step S104). For example, the first node 10 checks a job queue stored in the common storage.

In the information processing system 1, in a case where a job exists in a job queue (Step S105: Yes), the first node 10 executes the job (Step S106). For example, in a case where a job exists in a job queue, the first node 10 determines a job among jobs included in a job queue that is to be set as a processing target (will also be referred to as a “targeted job”), and executes the determined targeted job. For example, in a case where a job exists in a job queue, the first node 10 acquires a job from the job queue by performing processing (dequeue) of extracting a job from the job queue, and determines the acquired job as a targeted job. The first node 10 thereby executes processing using the job extracted from the job queue, as a targeted job.

In the information processing system 1, the first node 10 ends the job and registers a result (Step S107). For example, in a case where the first node 10 ends the processing of the targeted job, the first node 10 registers the processing result into the common storage. For example, in a case where the first node 10 ends the processing of the targeted job, the first node 10 registers the processing result in association with a job corresponding to the targeted job, among jobs in a job list stored in the common storage. Then, in the information processing system 1, after the processing in Step S107, the first node 10 returns the processing to Step S104, and repeats the processing.

In the information processing system 1, in a case where no job exists in a job queue (Step S105: No), the first node 10 sets the Master execution flag to False (Step S108). For example, the first node 10 sets the execution flag (first flag) to a state (second value) indicating that the master node is not executing processing. For example, the first node 10 changes a value of the first flag to the second value.

Then, in the information processing system 1, the first node 10 checks a Slave execution flag (Step S109). In a case where an execution flag (second flag) of the second node 20 is set to True (Step S109: True), the first node 10 returns the processing to Step S109, and repeats the processing. For example, in a case where the execution flag (second flag) of the second node 20 is set to a state (first value) indicating that a slave node is executing processing, the first node 10 returns the processing to Step S109, and repeats the processing. For example, in a case where a plurality of second nodes 20 exists, in a case where an execution flag of at least any one of second nodes 20 is set to True, the first node 10 returns the processing to Step S109, and repeats the processing.

On the other hand, in a case where an execution flag of the second node 20 is set to False (Step S109: False), the first node 10 ends the processing. For example, in a case where the execution flag (second flag) of the second node 20 is set to a state (second value) indicating that a slave node is not executing processing, the first node 10 ends the processing. For example, in a case where a plurality of second nodes 20 exists, in a case where execution flags of all the second nodes 20 are set to False, the first node 10 ends the processing.

As illustrated in FIG. 3, in the information processing system 1, the second node 20 serving as a slave node checks a Master execution flag (Step S201). In a case where an execution flag of the first node 10 is set to True (Step S201: True), the second node 20 checks a job queue (Step S202). For example, in a case where the execution flag of the first node 10 is set to a state indicating that the master node is executing processing, the second node 20 checks a job queue stored in a common storage accessible to each of a plurality of node.

In the information processing system 1, in a case where no job exists in a job queue (Step S203: No), the second node 20 returns the processing to Step S201, and repeats the processing.

In the information processing system 1, in a case where a job exists in a job queue (Step S203: Yes), the second node 20 sets a Slave execution flag to True (Step S204). For example, the second node 20 sets an execution flag (second flag corresponding to the own node) to a state (first value) indicating that a slave node is executing processing. For example, the second node 20 changes a value of the second flag to the first value.

Then, the second node 20 executes a job (Step S205). For example, in a case where a job exists in a job queue, the second node 20 determines a job among jobs included in a job queue that is to be set as a processing target (targeted job), and executes the determined targeted job. For example, in a case where a job exists in a job queue, the second node 20 acquires a job from the job queue by performing processing (dequeue) of extracting a job from the job queue, and determines the acquired job as a targeted job. The second node 20 thereby executes processing using the job extracted from the job queue, as a targeted job.

In the information processing system 1, the second node 20 ends the job and registers a result (Step S206). For example, in a case where the second node 20 ends the processing of the targeted job, the second node 20 registers the processing result into the common storage. For example, in a case where the second node 20 ends the processing of the targeted job, the second node 20 registers the processing result in association with a job corresponding to the targeted job, among jobs in a job list stored in the common storage. Then, the second node 20 sets a Slave execution flag to False (Step S207). For example, the second node 20 sets an execution flag (second flag corresponding to the own node) to a state (second value) indicating that a slave node is not executing processing. For example, the second node 20 changes a value of the second flag to the second value. Then, in the information processing system 1, after the processing in Step S207, the second node 20 returns the processing to Step S201, and repeats the processing.

In a case where the second node 20 determines that the execution flag of the first node 10 is set to False (Step S201: False), the second node 20 checks a standby mode option (Step S208). In a case where a standby mode option is ON (Step S208: ON), the second node 20 returns the processing to Step S201, and repeats the processing. On the other hand, in a case where a standby mode option is OFF (Step S208: OFF), the second node 20 ends the processing.

In addition, in the information processing system 1, a command to end a job being executed by a node may be received. For example, in the information processing system 1, in a case where job kill is executed (Step S301), execution of a corresponding job is ended. For example, in the information processing system 1, in a case where job kill of a master node is executed, execution of the master node is ended. For example, in the information processing system 1, in a case where job kill of the first node 10 is executed, execution of the first node 10 is ended. For example, in the information processing system 1, in a case where job kill of a slave node is executed, execution of the slave node is ended. For example, in the information processing system 1, in a case where job kill of the second node 20 is executed, execution of the second node 20 is ended. Note that, in the information processing system 1, the processing in Step S301 needs not be performed.

[1-4. Outline of Processing That Is Based on Master-Slave]

Next, an outline of information processing that is based on master-slave in the information processing system 1 will be described using FIG. 4. FIG. 4 is a diagram illustrating an outline of processing in an information processing system. For example, FIG. 4 illustrates a case where distributed processing is implemented (realized), using a Replication Controller of Kubernetes, in such a manner that large-scale parallel distributed processing can be realized in the information processing system 1. Note that the terminal device 50-1 and the terminal device 50-2 illustrated in FIG. 4 respectively indicate cases where the types of nodes (Pods) to be created are different. Note that, in a case where the terminal device 50-1 and the terminal device 50-2 will be described without distinction, the terminal device 50-1 and the terminal device 50-2 will be sometimes described as “the terminal devices 50”.

In FIG. 4, the terminal device 50-1 creates a Terminal Pod (corresponding to the first node 10) based on command information as illustrated in Step #1. Step #1 illustrated in the terminal device 50-1 indicates an example in which processing is executed in a Master mode (normal mode) on the Terminal Pod. For example, third to fifth rows in Step #1 indicate an example of a command (command information) for execution environment preparation. The Terminal Pod in FIG. 4 corresponds to a master node. The Terminal Pod in FIG. 4 is implemented on an AI Cloud Platform (ACP), which is a multitenant Kubernetes environment for data processing/machine learning/deep learning, for example.

The Terminal Pod in FIG. 4 manages a job queue and a database for processing result registration, in a common storage. For example, the common storage may be implemented by an object such as PersistentVolume of Kubernetes. For example, for exclusion control of a job queue, a lock file on the common storage, or the like is used. For example, a file on the common storage is used as an execution state flag.

In FIG. 4, the terminal device 50-2 creates two Optimizer Slave Pods (corresponding to second nodes 20) based on command information including “replicas: 2” designating the number of slave pods to be created, as illustrated in Step #2. In FIG. 2, out of the two Optimizer Slave Pods, an Optimizer Slave Pod—Replica #1 corresponds to the second node 20a, and an Optimizer Slave Pod—Replica #2 corresponds to the second node 20b. Step #2 illustrated in the terminal device 50-2 indicates an example case where two Optimizer Slave Pods are created.

For example, by changing a value of “replicas” of Step #2, an arbitrary number of Optimizer Slave Pods can be created, and scaling is executable. Each Optimizer Slave Pod in FIG. 4 corresponds to a slave node. Each Optimizer Slave Pod in FIG. 4 is implemented on an AI Cloud Platform (ACP), which is a multitenant Kubernetes environment for data processing/machine learning/deep learning, for example. For example, by the above-described processing, parallel distributed processing of several hundreds of arithmetic devices (graphics processing units (GPUs) or the like) can be executed in response to one command.

Each Optimizer Slave Pod in FIG. 4 acquires a job from a job queue, and executes the job (corresponding to 1. Get Trails and 2. Run in FIG. 4). Then, each Optimizer Slave Pod in FIG. 4 registers the result into a database (database for processing result registration) (corresponding to 3. Put Results in FIG. 4).

Similarly, a Terminal Pod in FIG. 4 acquires a job from a job queue, and executes the job (corresponding to 1. Get Trails and 2. Run in FIG. 4). Then, the Terminal Pod in FIG. 4 registers the result into a database (database for processing result registration) (corresponding to 3. Put Results in FIG. 4).

In this manner, in the example illustrated in FIG. 4, the Terminal Pod (corresponding to the first node 10) does not manage Optimizer Slave Pods (corresponding to the second nodes 20), and each of the Optimizer Slave Pods (corresponding to the second nodes 20) acquires a job from a job queue by itself, executes the job, and registers the result into the database.

For example, on a cloud service such as Kubernetes, a framework, a service, or the like that performs large-scale parallel distributed processing of arbitrary (original) processing has not conventionally existed. Thus, in a case where arbitrary large-scale parallel distributed processing (assumed to include several tens to several hundreds of parallel processes) is desired to be executed, a new system needs to be developed on a cloud service such as Kubernetes. The development requires labors, time, and cost.

On the other hand, as described above, by loosely coupling a Master (master node) and a Slave (slave node) of parallel distributed processing, and all nodes performing processing autonomously, it is possible to easily realize parallel distributed processing in the information processing system 1 using the ReplicationController of Kubernetes. As described above, the information processing system 1 is a cloud system, and divides information processing into a plurality of execution requests. Then, in the information processing system 1, if a master receives processing from the user, the master creates an execution request for realizing the processing. In the information processing system 1, the created execution request is stored into a storage region readable by a slave. In the information processing system 1, the slave refers to the storage, and executes an unexecuted execution request. The information processing system 1 sets a plurality of machines and a common storage in a cloud system, and registers an execution result obtained by a machine, into a common storage region.

[1-5. Configuration of Server Device]

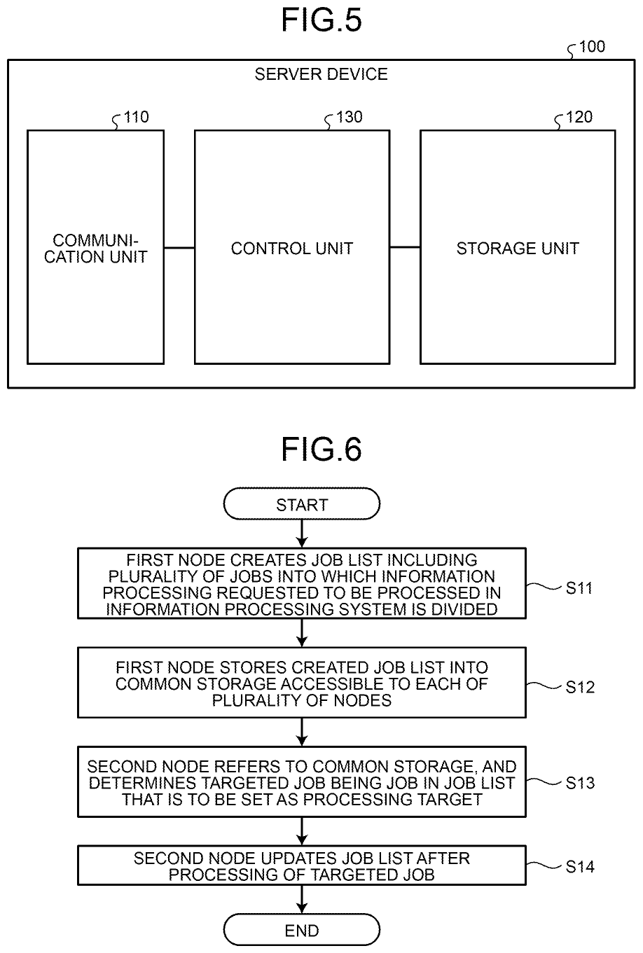

Next, a configuration of the server device 100 according to an embodiment will be described using FIG. 5. FIG. 5 is a diagram illustrating a configuration example of the server device 100 according to an embodiment. As illustrated in FIG. 5, the server device 100 includes a communication unit 110, a storage unit 120, and a control unit 130. Note that the server device 100 may include an input unit (for example, keyboard, mouse, or the like) for receiving various operations from an administrator or the like of the server device 100, and a display unit (for example, a liquid crystal display or the like) for displaying various types of information.

(Communication Unit 110)

The communication unit 110 is implemented by a network interface card (NIC) or the like, for example. Then, the communication unit 110 is connected with a predetermined communication network (network) in a wired or wireless manner, and performs information transmission and reception with the terminal device 50 and other server devices 100.

(Storage Unit 120)

The storage unit 120 is implemented by a semiconductor memory device such as a random access memory (RAM) or a flash memory, or a storage device such as a hard disk or an optical disk, for example. For example, in a case where the storage unit 120 corresponds to the server device 100 including a common storage (for example, the server device 100 corresponding to the first node 10, or the like), the storage unit 120 stores various types of information stored in the common storage. In this case, the storage unit 120 stores various types of information regarding a job list, a job queue, and the like. For example, the storage unit 120 stores a job list and a job queue. For example, the storage unit 120 stores a processing result of each job included in a job list.

For example, in the case of the server device 100 corresponding to the first node 10, the storage unit 120 stores at least the first flag. For example, in the case of the server device 100 corresponding to the first node 10, the storage unit 120 may store the first flag and the second flag. For example, in the case of the server device 100 corresponding to the second node 20, the storage unit 120 may store the second flag. Note that the above-described information is merely an example, and the storage unit 120 stores various types of information necessary for processing.

(Control Unit 130)

Referring back to FIG. 5, the control unit 130 is a controller, and is implemented by various programs (corresponding to an example of an information processing program) stored in a storage device inside the server device 100, being executed by a central processing unit (CPU), a graphics processing unit (GPU), a micro processing unit (MPU), or the like, for example, using a RAM as a work area. In addition, the control unit 130 is a controller, and is implemented by an integrated circuit such as an application specific integrated circuit (ASIC) or a Field Programmable Gate Array (FPGA), for example.

The control unit 130 functions as an execution unit that executes various types of processing. The control unit 130 functions as a processor that processes a task.

The control unit 130 functions as an acquisition unit that acquires various types of information. For example, the control unit 130 acquires various types of information from the storage unit 120. The control unit 130 acquires various types of information from another information processing device. The control unit 130 acquires various types of information from the terminal device 50 and another server device 100. The control unit 130 receives, via the communication unit 110, information from the terminal device 50 and another server device 100.

The control unit 130 receives, via the communication unit 110, various requests from the terminal device 50 used by the user. The control unit 130 executes processing suitable for various request from the terminal device 50. The control unit 130 functions as a request unit that issues various requests.

The control unit 130 functions as a creation unit that creates various types of information. The control unit 130 creates various types of information using information stored in the storage unit 120. The control unit 130 functions as a determination unit that executes determination processing. The control unit 130 determines various types of information using information stored in the storage unit 120.

The control unit 130 functions as a provision unit that provides various types of information. The control unit 130 transmits information to the terminal device 50 via the communication unit 110. The control unit 130 provides an information providing service to the terminal device 50 used by the user.

The control unit 130 refers to the common storage, and determines a job in the job list that is to be set as a processing target (targeted job). The control unit 130 refers to the common storage, and determines an unprocessed job in the job list as a targeted job. The control unit 130 updates the job list after processing of the targeted job. The control unit 130 refers to a job queue set based on the job list, and determines a job included in the job queue, as a targeted job.

In the case of the server device 100 corresponding to the first node 10, the control unit 130 creates a job list including a plurality of jobs into which information processing requested to be processed in the information processing system 1 is divided. The control unit 130 creates a plurality of jobs by dividing targeted information processing by an arbitrary method appropriately using various prior arts. In the case of the server device 100 corresponding to the first node 10, the control unit 130 stores the created job list into a common storage accessible to each of a plurality of nodes.

In the case of the server device 100 corresponding to the first node 10, the control unit 130 sets a value of a first flag (Master execution flag) for managing an execution state of the own device (the first node 10). In this case, the control unit 130 sets (change) a value of the first flag stored in the storage unit 120, for example. In the case of the server device 100 corresponding to the first node 10, in a case where the first node 10 has started processing, the control unit 130 sets the first flag to a first value corresponding to ongoing. In the case of the server device 100 corresponding to the first node 10, the control unit 130 ends the processing in a case where the first flag is set to a second value indicating that the processing of the first node 10 has been completed, and the second flag is set to a second value indicating that the processing of the second node 20 has been completed.

In the case of the server device 100 corresponding to the second node 20, the control unit 130 sets a value of the second flag (False execution flag) for managing an execution state of the own device (the second node 20). In this case, the control unit 130 sets (change) a value of the second flag stored in the storage unit 120, for example. In the case of the server device 100 corresponding to the second node 20, in a case where the first flag is set to the first value, the control unit 130 refers to the common storage, determines a job as a targeted job, and executes processing of the targeted job. In the case of the server device 100 corresponding to the second node 20, in a case where the second node 20 has started processing, the control unit 130 sets the second flag to a first value corresponding to ongoing.

[2. Processing Procedure]

Next, a procedure of information processing to be executed by the information processing system 1 according to an embodiment will be described using FIG. 6. FIG. 6 is a flowchart illustrating a procedure of processing according to an embodiment.

As illustrated in FIG. 6, in the information processing system 1, the first node 10 creates a job list including a plurality of jobs into which information processing requested to be processed in the information processing system 1 is divided (Step S11). For example, the server device 100 implementing the first node 10 creates a job list including a plurality of jobs into which information processing requested to be processed in the information processing system 1 is divided. For example, the server device 100a corresponding to the first node 10 creates a job list including a plurality of jobs into which information processing requested to be processed in the information processing system 1 is divided.

In the information processing system 1, the first node 10 stores the created job list into a common storage accessible to each of a plurality of nodes (Step S12). For example, the server device 100 implementing the first node 10 stores the created job list into a common storage accessible to each of a plurality of nodes (for example, the storage unit 120 of the server device 100 itself). For example, the server device 100a corresponding to the first node 10 stores the created job list into a common storage accessible to each of a plurality of nodes (for example, the storage unit 120 of the server device 100a itself).

In the information processing system 1, the second node 20 refers to the common storage, and determines a targeted job being a job in the job list that is to be set as a processing target (Step S13). For example, the server device 100 implementing the second node 20 refers to the common storage (for example, the storage unit 120 of the server device 100 implementing the first node 10), and determines a targeted job being a job in the job list that is to be set as a processing target. For example, the server device 100b corresponding to the second node 20a refers to the common storage (for example, the storage unit 120 of the server device 100a corresponding to the first node 10), and determines a targeted job being a job in the job list that is to be set as a processing target.

In the information processing system 1, the second node 20 updates a job list after processing of the targeted job (Step S14). For example, the server device 100 implementing the second node 20 updates a job list after processing of the targeted job. For example, the server device 100b corresponding to the second node 20 updates a job list stored in the storage unit 120 of the server device 100a corresponding to the first node 10, after processing of the targeted job.

[3. Effect]

As described above, the information processing system 1 according to the present application is the information processing system 1 including a plurality of nodes including a first node and a second node that execute distributed processing, in which the first node 10 creates a job list including a plurality of jobs into which information processing requested to be processed in the information processing system 1 is divided, and stores the created job list into a common storage accessible to each of the plurality of nodes, and the second node 20 refers to the common storage, determines a targeted job being a job in the job list that is to be set as a processing target, and updates the job list after processing of the targeted job.

With this configuration, the information processing system 1 according to an embodiment can enable appropriate distributed processing because the second node 20 can execute a job irrespective of allocation from the first node 10, by the second node 20 determining a targeted job by referring to a common storage, and updating a job list after processing of the targeted job.

In addition, in the information processing system 1 according to an embodiment, the first node 10 is a master node and the second node 20 is a slave node. With this configuration, the information processing system 1 according to an embodiment can enable appropriate distributed processing by master-slave divided processing.

In addition, in the information processing system 1 according to an embodiment, the second node 20 refers to the common storage, and determines an unprocessed job in the job list as a targeted job. With this configuration, the information processing system 1 according to an embodiment can enable appropriate distributed processing by the second node 20 sequentially processing unprocessed jobs in a job list.

In addition, in the information processing system 1 according to an embodiment, the second node 20 refers to a job queue set based on the job list, and determines a job included in the job queue, as a targeted job. With this configuration, the information processing system 1 according to an embodiment can enable appropriate distributed processing by the second node 20 sequentially processing unprocessed jobs in a job list by referring to a job queue.

In addition, in the information processing system 1 according to an embodiment, the first node 10 refers to a common storage, determines a targeted job in a job list that is to be set as a processing target, and updates the job list after processing of the targeted job. With this configuration, the information processing system 1 according to an embodiment can enable appropriate distributed processing by the first node 10 determining a targeted job by referring to a common storage, and updating a job list after processing of the targeted job.

In addition, in the information processing system 1 according to an embodiment, the first node 10 refers to a job queue set based on the job list, and determines a job included in the job queue, as a targeted job. With this configuration, the information processing system 1 according to an embodiment can enable appropriate distributed processing by the first node 10 sequentially processing unprocessed jobs in a job list by referring to a job queue.

In addition, the information processing system 1 according to an embodiment executes the distributed processing using the first flag for managing an execution state of the first node 10, and the second flag for managing an execution state of the second node 20. With this configuration, the information processing system 1 according to an embodiment can enable appropriate distributed processing by using two types of flags including the first flag corresponding to the first node 10, and the second flag corresponding to the second node 20.

In addition, in the information processing system 1 according to an embodiment, in a case where the first node 10 has started processing, the first node 10 sets the first flag to a first value corresponding to ongoing. With this configuration, the information processing system 1 according to an embodiment can enable appropriate distributed processing by the first node 10 setting a value of the first flag in accordance with the status of itself.

In addition, in the information processing system 1 according to an embodiment, in a case where the first flag is set to the first value, the second node 20 refers to the common storage, determines a job as a targeted job, and executes processing of the targeted job. With this configuration, the information processing system 1 according to an embodiment can enable appropriate distributed processing by the second node 20 determining a targeted job by referring to a common storage, and executing processing of the targeted job, in accordance with the status of the first node 10.

In addition, in the information processing system 1 according to an embodiment, in a case where the second node 20 has started processing, the second node 20 sets the second flag to a first value corresponding to ongoing. With this configuration, the information processing system 1 according to an embodiment can enable appropriate distributed processing by the second node 20 setting a value of the second flag in accordance with the status of itself.

In addition, in the information processing system 1 according to an embodiment, the first node 10 ends the processing in a case where the first flag is set to a second value indicating that the processing of the first node 10 has been completed, and a second flag is set to a second value indicating that the processing of the second node 20 has been completed. With this configuration, the information processing system 1 according to an embodiment can enable appropriate distributed processing by the first node 10 ending the processing based on two types of flags including the first flag corresponding to the first node 10, and the second flag corresponding to the second node 20.

[4. Hardware Configuration]

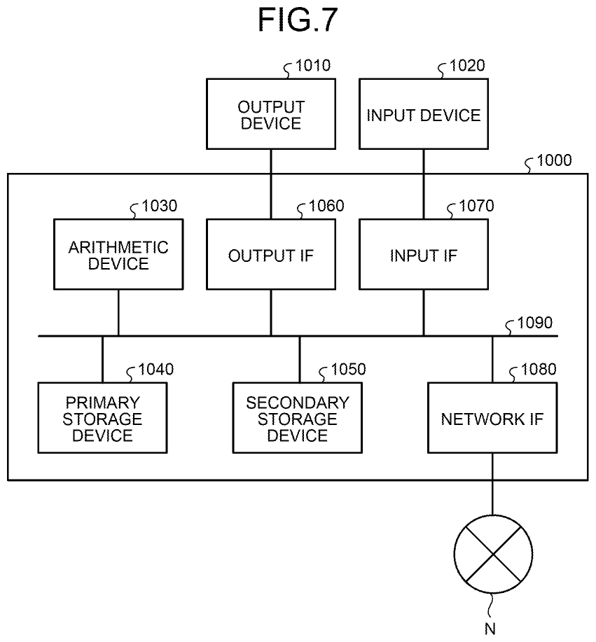

In addition, the terminal device 50 and the server device 100 according to the above-described embodiment are implemented by a computer 1000 having a configuration as illustrated in FIG. 7, for example. Hereinafter, the description will be given using the server device 100 as an example. FIG. 7 is a diagram illustrating an example of a hardware configuration. The computer 1000 is connected with an output device 1010 and an input device 1020, and has a configuration in which an arithmetic device 1030, a primary storage device 1040, a secondary storage device 1050, an output interface (IF) 1060, an input IF 1070, and a network IF 1080 are connected via a bus 1090.

The arithmetic device 1030 operates based on programs stored in the primary storage device 1040 and the secondary storage device 1050, programs read out from the input device 1020, and the like, and executes various types of processing. The arithmetic device 1030 is implemented by, for example, a central processing unit (CPU), a graphics processing unit (GPU), a micro processing unit (MPU), an application specific integrated circuit (ASIC), a Field Programmable Gate Array (FPGA), or the like.

The primary storage device 1040 is a memory device such as a random access memory (RAM) that primarily stores data to be used by the arithmetic device 1030 for various types of calculation. In addition, the secondary storage device 1050 is a storage device into which data to be used by the arithmetic device 1030 for various types of calculation, and various databases are registered, and is implemented by a read only memory (ROM), a hard disk drive (HDD), a solid state drive (SSD), a flash memory, or the like. The secondary storage device 1050 may be an embedded storage or may be an external storage. In addition, the secondary storage device 1050 may be a removable storage medium such as a universal serial bus (USB) memory or a secure digital (SD) memory card. In addition, the secondary storage device 1050 may be a cloud storage (online storage), a network attached storage (NAS), a file server, or the like.

The output IF 1060 is an interface for transmitting information to be output, to the output device 1010 such as a display, a projector, or a printer that outputs various types of information, and is implemented by a connector complying with a standard such as such as a universal serial bus (USB), a digital visual interface (DVI), or a high definition multimedia interface (HDMI) (registered trademark), for example. In addition, the input IF 1070 is an interface for receiving information from various input devices 1020 such as a mouse, a keyboard, a keypad, a button, and a scanner, and is implemented by a USB or the like, for example.

In addition, the output IF 1060 and the input IF 1070 may be wirelessly connected with the output device 1010 and the input device 1020, respectively. In other words, the output device 1010 and the input device 1020 may be wireless devices.

In addition, the output device 1010 and the input device 1020 may be integrated like a touch panel. In this case, the output IF 1060 and the input IF 1070 may also be integrated as an input-output IF.

Note that the input device 1020 may be a device that reads out information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like, for example.

The network IF 1080 receives data from another device via the network N and transmits the data to the arithmetic device 1030, and also transmits data created by the arithmetic device 1030, to another device via the network N.

The arithmetic device 1030 controls the output device 1010 and the input device 1020 via the output IF 1060 and the input IF 1070, respectively. For example, the arithmetic device 1030 loads programs from the input device 1020 and the secondary storage device 1050 onto the primary storage device 1040, and executes the loaded programs.

For example, in a case where the computer 1000 functions as the server device 100, the arithmetic device 1030 of the computer 1000 implements the functions of the control unit 130 by executing programs loaded onto the primary storage device 1040. In addition, the arithmetic device 1030 of the computer 1000 may load programs acquired from another device via the network IF 1080, onto the primary storage device 1040, and execute the load programs. In addition, the arithmetic device 1030 of the computer 1000 may cooperate with another device via the network IF 1080, call functions, data, and the like of programs from other programs of another device, and use the functions, data, and the like.

[5. Others]

Heretofore, the embodiments of the present application have been described, but the present invention is not limited by the content of these embodiments. In addition, the above-described components include components easily conceivable by those skilled in the art, substantially the same components, and components falling within a so-called equal scope. Furthermore, the above-described components can be appropriately combined. Furthermore, various omissions, replacements, and changes can be made on the components without departing from the gist of the above-described embodiment.

In addition, among processes described in the above-described embodiment, all or part of processes described to be automatically performed can also be manually performed, or all or part of processes described to be manually performed can also be automatically performed by a known method. Aside from this, processing procedures, specific names, and information including various types of data and parameters, which have been described in the above-described document and are illustrated in the drawings, can be arbitrarily changed unless otherwise specified. For example, various types of information illustrated in the drawings are not limited to information illustrated in the drawings.

In addition, each component of each device illustrated in the drawings indicates functional concept, and is not required to always include a physical configuration as illustrated in the drawings. In other words, a specific configuration of distribution and integration of devices is not limited to that illustrated in the drawings, and all or part of the devices can be functionally or physically distributed or integrated in an arbitrary unit in accordance with various loads and usage statuses.

For example, the above-described server device 100 may be implemented by a plurality of server computers. In addition, a configuration can be flexibly changed by implementing the server device 100 by calling an external platform or the like using an application programming interface (API), network computing, or the like, depending on the functions.

In addition, the above-described embodiments and modified examples can be appropriately combined without generating contradiction in processing content.

In addition, the above-described “unit (section, module, unit)” can also be reworded as “means”, a “circuit”, or the like. For example, the control unit can be reworded as control means or a control circuit.

### EXPLANATIONS OF LETTERS OR NUMERALS

1 Information processing system
2 Distributed processing system
50 Terminal device
100 Server device (information processing device)
110 Communication unit
120 Storage unit
130 Control unit

1. An information processing system comprising a plurality of nodes including a first node and a second node that execute distributed processing,
wherein the first node creates a job list including a plurality of jobs into which information processing requested to be processed in the information processing system is divided, and stores the created job list into a common storage accessible to each of the plurality of nodes, and
wherein the second node refers to the common storage, determines a targeted job being a job in the job list that is to be set as a processing target, and updates the job list after processing of the targeted job.

2. The information processing system according to claim 1,
wherein the first node is a master node, and
wherein the second node is a slave node.

3. The information processing system according to claim 1,
wherein the second node refers to the common storage, and determines an unprocessed job in the job list as the targeted job.

4. The information processing system according to claim 3,
wherein the second node refers to a job queue set based on the job list, and determines a job included in the job queue, as the targeted job.

5. The information processing system according to claim 1,
wherein the first node refers to the common storage, determines the targeted job in the job list that is to be set as a processing target, and updates the job list after processing of the targeted job.

6. The information processing system according to claim 5,
wherein the first node refers to a job queue set based on the job list, and determines a job included in the job queue, as the targeted job.

7. The information processing system according to claim 1,
wherein distributed processing is executed using a first flag for managing an execution state of the first node, and a second flag for managing an execution state of the second node.

8. The information processing system according to claim 7,
wherein, in a case where the first node has started processing, the first node sets the first flag to a first value corresponding to ongoing.

9. The information processing system according to claim 8,
wherein, in a case where the first flag is set to the first value, the second node refers to the common storage, determines a job as the targeted job, and executes processing of the targeted job.

10. The information processing system according to claim 7,
wherein, in a case where the second node has started processing, the second node sets the second flag to a first value corresponding to ongoing.

11. The information processing system according to claim 7,
wherein the first node ends processing in a case where the first flag is set to a second value indicating that processing of the first node has been completed, and the second flag is set to the second value indicating that processing of the second node has been completed.

12. An information processing method to be executed by an information processing system including a plurality of nodes including a first node and a second node that execute distributed processing, the information processing method comprising:
the first node creating a job list including a plurality of jobs into which information processing requested to be processed in the information processing system is divided, and storing the created job list into a common storage accessible to each of the plurality of nodes; and
the second node referring to the job list, determining a targeted job being a job in the job list that is to be set as a processing target, and updating the job list after processing of the targeted job.
